(19) United States
(12) Patent Application Publication
(10) Pub. No.: US 2017/0039627 A1
(43) Pub. Date: Feb. 9, 2017

(54) Cigar Band Recognition Interface

(71) Applicants: Rukhsana Kalvin, Fort Myers, FL (US); John A. Rousseau, Naples, FL (US)

(72) Inventors: Rukhsana Kalvin, Fort Myers, FL (US); John A. Rousseau, Naples, FL (US)

(21) Appl. No.: 14/819,242

(22) Filed: Aug. 5, 2015

(51) Int. Cl. G06Q 30/06; G06T 3/00; H04N 13/02; G06F 17/30; A24D 1/16; G06K 9/62

(52) U.S. Cl. CPC G06Q 30/0643; A24D 1/16; G06K 9/6201; H04N 13/0203; G06K 9/6267; G06F 17/3028; G06T 3/00; G06Q 30/0631

(57) ABSTRACT

The present invention comprise a cigar band recognition interface which further comprises a network device having a transceiver; and a processor that is operative to perform actions, comprising: scanning a cigar band to create a cigar band image; comparing the cigar band image with at least one other cigar band image which is catalogued, indexed, and stored to determine a cigar brand; and displaying to a user said cigar brand and at least one price of said cigar brand. Additionally, the network device may further process data over a network, including comparing the cigar band image with the at least one other cigar band image further comprises comparing with the received geographical location marker with at least one known geographical marker of a distributor of said cigar brand, where a proximity marker is used to determine whether a physical distribution location is displayed or whether an ecommerce platform is displayed.

### PRIORITY CLAIM TO PREVIOUSLY FILED PROVISIONAL APPLICATION

This application claims the benefit of priority to Provisional Patent Application No. 62/033,710 filed on Aug. 6, 2014.

### FIELD OF THE INVENTION

The present invention relates to an image recognition interface that enables a user to determine a cigar brand, cost and purchase location based on a user created image of said cigar band.

### BACKGROUND OF THE INVENTION

An image recognition interface can act to provide a brand name for an unknown product to a user. A typical image recognition interface includes an interface from which a user captures an image using a specific application on a device, for example, a bar code reader, to determine a price or other sale locations of product within a department or box store.

### SUMMARY OF THE INVENTION

It is, therefore, an object of the present invention to provide an image recognition interface whereby a user can create a three-dimensional image or picture of cigar band artwork and from this three-dimensional image, be provided a cigar brand, rating, a price, and a distribution location through a number of active or passive embodiments, which may or may not include active or passive predictive advertising of other recommended cigar brands. It is another object of the present invention to provide a network device, a system for using the network device, and non-transitory computer readable storage media containing computer-executable instructions which can enable the network device or any other computing device to engage in the image recognition interface, once the instructions are installed on the device.

An exemplary environment for the present invention can include, but is not limited to, a communication network environment, combining local area networks, wide area networks, and wireless networks through the use of user devices, as well as any other environment in network communication and the use of a cigar band image recognition interface is desired. Mobile computing and communication devices are contemplated to be used in this environment, for example, including but not limited to, a mobile device “smartphone,” or wireless-enabled “tablet” computing device.

In an exemplary embodiment of the present invention, a network device can include a transceiver and a processor.

In an exemplary aspect of the present network device, the transceiver can send and receive data over a network.

In another exemplary aspect of the present network device, the processor can be operative on the received data to perform actions.

In a further exemplary aspect of the present network device, the processor can perform such actions, for example, as scanning a cigar band to create a cigar band image.

In another exemplary aspect of the present network device, the processor can perform further actions, such as, for example, comparing the cigar band image with at least one other cigar band image which is catalogued, indexed, and stored to determine a cigar brand.

In still another exemplary aspect of the present network device, the processor can perform further actions, such as, for example, displaying to a user said cigar brand and at least one price of said cigar brand.

The following are additional and/or exemplary aspects of the present network device, one or more of which can be combined with the basic network device and its elements, as embodied above:
receiving a geographical location marker for the network device scanning the cigar band; wherein, comparing the cigar band image with the at least one other cigar band image further comprises comparing with the received geographical location marker with at least one known geographical location marker of a distributor of said cigar brand, where a proximity marker is used to determine whether at least one physical distribution location is displayed or whether at least one ecommerce platform is displayed;
displaying to the user at least one cigar rating determined by comparison of said cigar brand to a database of at least one other cigar rating;
cataloguing, indexing, and storing the cigar brand image at a time of determining said cigar brand, wherein the catalogued, indexed and saved cigar band image is used for at least one other comparison; and wherein the user can access all saved cigar band images on a network device;
providing the user with one or more interface display screens on which the user selects at least one user preference, wherein selecting at least one user preference allows the user to:
   create at least one text and image note connected to the scanned cigar band image;
   send and receive the scanned cigar band image via a social media platform or other internet based communications methods; and
   select at least one user preference which allows for a remote network device to provide at least one other cigar brand to the user based on the scanned cigar band image;
scanning a three dimensional image of the cigar band to create the cigar band image flattening said three dimensional image to determine at least one image marker; and
recognizing said cigar brand based on the at least one image marker;
imposing a grid over the scanned cigar band image to create at least one image marker; and
assigning a value to the at least one image marker based on a value table comprised of values assigned to at least one cigar band image by at least one cigar manufacturer.

In an exemplary embodiment of the present invention, a system can include a one or more user devices and a network device.

In an exemplary aspect of the present network system, the network device further comprises a processor and the network device is configured, through the processor, to communicate with the one or more user devices over a network.

In a further exemplary aspect of the present system, network device is further configured to perform such actions, for example, as scanning, via the network device, a cigar band to create a cigar band image.

In another exemplary aspect of the present system, the network device can be configured to perform further actions, such as, for example, comparing, via the network device, the cigar band image with at least one other cigar band image which is catalogued, indexed, and stored to determine a cigar brand.

In still another exemplary aspect of the present system, the network device can be configured to perform further actions, such as, for example, displaying, via the network device, to a user said cigar brand and at least one price of said cigar brand.

The following are additional and/or exemplary aspects of the present system, one or more of which can be combined with the basic system and its elements, as embodied above:
A network device further configured to perform any and/or all of the following exemplary actions, or more of which can be combined with the basic system embodied above, for example:
   receiving a geographical location marker for the network device scanning the cigar band; wherein, comparing the cigar band image with the at least one other cigar band image further comprises comparing with the received geographical location marker with at least one known geographical location marker of a distributor of said cigar brand, where a proximity marker is used to determine whether at least one physical distribution location is displayed or whether at least one ecommerce platform is displayed;
displaying to the user at least one cigar rating determined by comparison of said cigar brand to a database of at least one other cigar rating;
cataloguing, indexing, and storing the cigar brand image at a time of determining said cigar brand, wherein the catalogued, indexed and saved cigar band image is used for at least one other comparison; and wherein the user can access all saved cigar band images on a network device;
providing the user with one or more interface display screens on which the user selects at least one user preference, wherein selecting at least one user preference allows the user to:
   create at least one text and image note connected to the scanned cigar band image;
   send and receive the scanned cigar band image via a social media platform or other internet based communications methods; and
   select at least one user preference which allows for a remote network device to provide at least one other cigar brand to the user based on the scanned cigar band image;
scanning a three dimensional image of the cigar band to create the cigar band image flattening said three dimensional image to determine at least one image marker; and
recognizing said cigar brand based on the at least one image marker;
imposing a grid over the scanned cigar band image to create at least one image marker; and
assigning a value to the at least one image marker based on a value table comprised of values assigned to at least one cigar band image by at least one cigar manufacturer.

In another exemplary embodiment of the present invention, a non-transitory computer readable storage medium can include computer-executable instructions, the computer executable instructions when installed onto a computing device enable the computing device to perform actions.

In an exemplary aspect of the present computer-executable instructions, the computing device can be enabled to scan a cigar band to create a cigar band image

In another exemplary aspect of the present computer-executable instructions, the computing device can be further enabled to compare the cigar band image with at least one other cigar band image which is catalogued, indexed and stored to determine a cigar brand.

In still another exemplary aspect of the present computer-executable instructions, the computing device can be further enabled to display to the user the cigar brand and at least one price of the cigar brand.

The following are additional and/or exemplary aspects of the present computer-executable instructions, whereby the computing device can be further enabled to perform one or more of the following actions, alone or in combination with the basic system, the basic network device and its elements and the basic non-transitory computer readable storage medium, as embodied above:

receiving a geographical location marker for the network device scanning the cigar band; wherein, comparing the cigar band image with the at least one other cigar band image further comprises comparing with the received geographical location marker with at least one known geographical location marker of a distributor of said cigar brand, where a proximity marker is used to determine whether at least one physical distribution location is displayed or whether at least one ecommerce platform is displayed;

displaying to the user at least one cigar rating determined by comparison of said cigar brand to a database of at least one other cigar rating;

cataloguing, indexing, and storing the cigar brand image at a time of determining said cigar brand, wherein the catalogued, indexed and saved cigar band image is used for at least one other comparison; and wherein the user can access all saved cigar band images on a network device;

providing the user with one or more interface display screens on which the user selects

at least one user preference, wherein selecting at least one user preference allows the user to:

create at least one text and image note connected to the scanned cigar band image;

send and receive the scanned cigar band image via a social media platform or other internet based communications methods; and

select at least one user preference which allows for a remote network device to provide at least one other cigar brand to the user based on the scanned cigar band image;

scanning a three dimensional image of the cigar band to create the cigar band image;

flattening said three dimensional image to determine at least one image marker; and

recognizing said cigar brand based on the at least one image marker;

imposing a grid over the scanned cigar band image to create at least one image marker; and

assigning a value to the at least one image marker based on a value table comprised of values assigned to at least one cigar band image by at least one cigar manufacturer.

These and other exemplary aspects of the present invention are described herein.

Those skilled in the art will recognize still other aspects of the present invention upon reading and understanding the attached description.

### BRIEF DESCRIPTION OF THE DRAWINGS

The present invention is illustrated by way of example, and not in limitation, in the figures of the accompanying drawings.

For a better understanding of the present invention and its embodiments, reference will be made to the following detailed description, which is to be read in association with the accompanying drawings.

FIG. 1 illustrates one embodiment of a user entity device that can be included in a system implementing cigar band image recognition.

FIG. 2 illustrates one embodiment of creation a cigar band image.

FIG. 3 illustrates a system diagram of one embodiment of a network environment in which cigar band image recognition can be practiced.

FIG. 4 illustrates a logical flow diagram generally showing one embodiment of a process for cigar band image recognition using a network device.

### DETAILED DESCRIPTION OF THE INVENTION

The present invention will now be described more fully herein after with reference to the accompanying drawings, which form a part hereof, and which show, by way of illustration, specific exemplary embodiments by which the invention may be practiced. This invention may, however, be embodied in many different forms and should not be construed as limited to the exemplary embodiments set forth herein. Rather, these exemplary embodiments are provided so that this disclosure will be thorough and complete, and will fully convey the scope of the invention to those skilled in the art. Among other things, the present invention may be embodied as methods or devices. Accordingly, various exemplary embodiments may take the form of an entirely hardware embodiments, an entirely software embodiment and/or an embodiment combining software and hardware aspects. The following detailed description, is, therefore, not to be taken in a limiting sense.

Throughout the specification and claims, the following terms take the meanings explicitly associated herein, unless the context clearly otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

The following briefly describes the embodiments of the invention in order to provide a basic understanding of some aspects of the invention. This brief description is not intended as an extensive overview. It is not intended to identify key or critical elements, or to delineate or otherwise narrow the scope. its purpose is merely to present some concepts in a simplified form as a prelude to the more detailed description that is presented later.

The present invention, generally, is directed towards providing an interface and/or user application for a user to learn about a cigar brand based on an image created of the cigar band artwork. Such application is directed towards providing an opportunity for a user to create an online identity, including many factors such as personal preferences, geographic location preferences and/or internet ecommerce platform browsing preferences and/or predictive advertising preferences.

Such application may optionally further include a database of cigar band artwork which can be index and catalogued based on a variety of different features of the artwork, or as determined by the cigar manufactures. An image recognition feature would allow a user to create a cigar band image using a cigar in hand, a cigar display, or through an image created by a third party, for example, an image created using a website ecommerce platform. The created cigar band image may then be analyzed as a feature of the user application and compared against the database of cigar band artwork, so that a brand may be determined, a physical location to purchase may be determined, or an ecommerce platform to purchase may be determined. Further features of the user application may allow for a user to create notes, personal images or share information relating to the cigar band image and/or the determined brand via social media platforms, email, or any other user generated method of information dissemination.

Image recognition applications, generally, include methods for acquiring, processing, analyzing, and understanding images and, in general, high-dimensional data from the real world in order to produce numerical or symbolic information, also generally known as decisions. A theme in the development of this field has been to duplicate the abilities of human vision by electronically perceiving and understanding an image. This image understanding can be seen as the disentangling of symbolic information from image data using models constructed with the aid of geometry, physics, statistics, and learning theory. Image recognition has also been described as the enterprise of automating and integrating a wide range of processes and representations for vision perception.

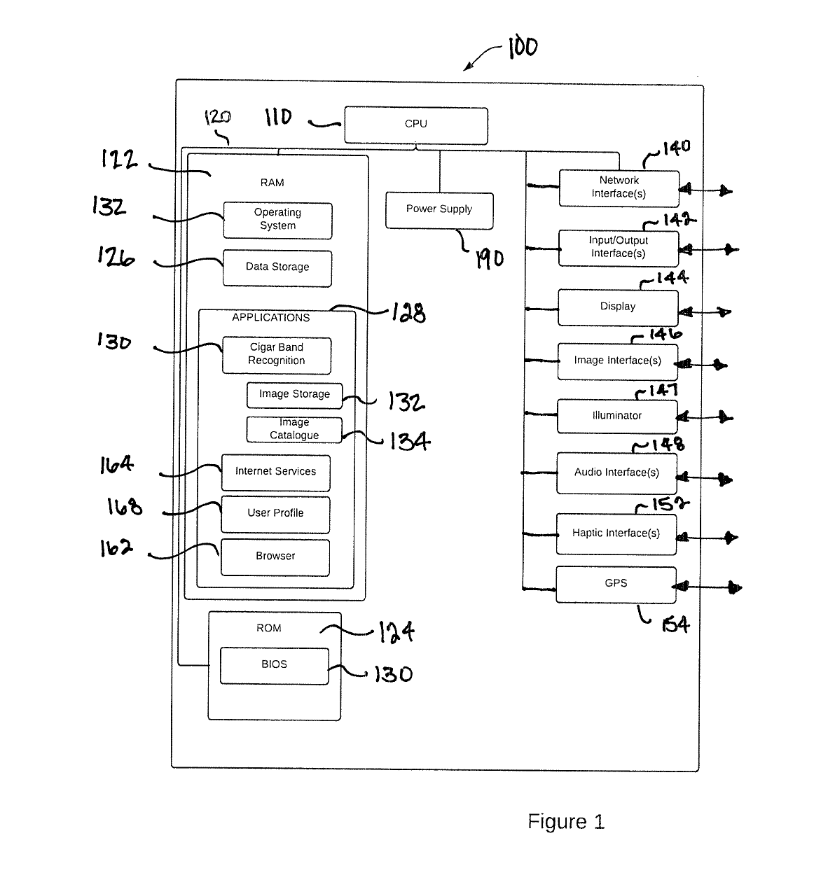

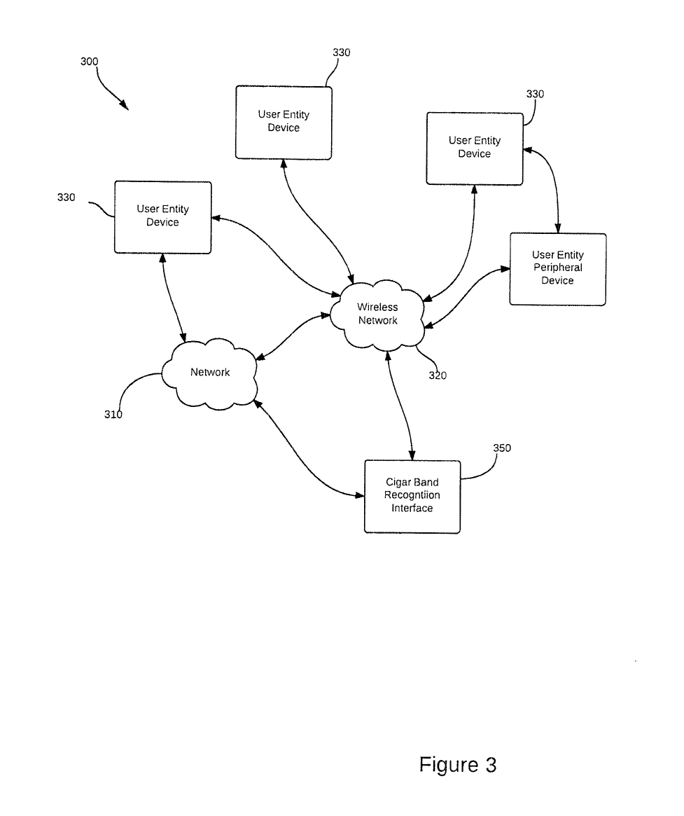

FIG. 1 shows one embodiment of user device 100 that may be used to implement the inventive cigar band recognition interface. User entity device 100 may include many more or less components than those shown in FIG. 1. However, the components shown are sufficient to disclose an illustrative embodiment for practicing the invention. Client device 100 may represent, for example, one embodiment of at least one of client devices 330 as illustrated below in reference to FIG. 3.

As shown in the figure, client device 100 includes a processing unit (CPU) 110 in communication with a mass memory 120 via a bus 192. Mass memory 120 includes a RAM 122, a ROM 124, and other storage means. Mass memory 120 illustrates an example of computer readable storage media (devices) for storage of information such as computer readable instructions, data structures, program nodules or other data. Mass memory 120 stores a basic input/output system (“BIOS”) 130 for controlling low-level operation of client device 100. The mass memory also stores an operating system 132 for controlling the operation of client device 100. It will be appreciated that this component may include a general-purpose operating system such as a version of UNIX, or LINUX™, or a specialized client communication operating system such as Windows Mobile™, Android® operating system, or the Symbian® operating system. The operating system may include, or interface with Java virtual machine module that enables control of hardware components and/or operating systems operations via Java application programs.

Memory 120 further includes one or more data storage 126, which can be utilized by client device 100 to store, among other things, applications 128 and/or other data. For example, data storage 126 may also be employed to store information that describes various capabilities of client device 100. The information may then be provided to another device based on any of a variety of events, including being sent as part of a header during a communication, sent upon request, or the like. Data storage 126 may also be employed to store cigar band recognition interface information including cigar band images, archived artwork files, user profile information, or the like. Further, as illustrated, data storage 126 may also store information about cigar band images, data collected from one or more images, including pixel (size) data, image count data, or the like. At least a portion of the information may be stored on a disk drive or other computer-readable storage device (not shown) within client device 100.

Applications 128 may include computer executable instructions which, when executed by client device 100, transmit, receive, and/or otherwise process cigar band images, other device functions, for example, such as messages, audio, video, and enable telecommunication with another user of another client device. Other examples of application programs include calendars, search programs, email clients, IM applications, SMS applications, VOIP applications, contact managers, task managers, transcoders, database programs, word processing programs, security applications, spreadsheet programs, games, search programs, and so forth.

In one embodiment of applications 128, for example, one application can be a cigar band recognition application 130, which can optionally include an image storage 132, an image catalogue storage 134, and a user profile storage 136. Cigar band recognition application 130 can optionally function with other components and/or peripherals of client device 100, to complete functions necessary to operate the application 130. For example, application 130 can operatively integrate features of image interface 146. Integration of features may include, for example, but are not limited to, capturing an image of cigar band using an image capture feature, displaying an image of a cigar band using an image display feature, and/or preparing for transmission a cigar band image via the network interface, as described more fully below.

Image storage 132 can optionally be an integrated feature of data storage 126, and/or, a separate and individual storage element as needed, depending on the operating system in use on client device 100.

Image catalogue storage 134 can also optionally be an integrated feature of data storage 126, and/or a separate and individual storage element as needed, depending on the operating system in use on client device 100. In an additional embodiment of image catalogue storage 134, image catalogue storage 134 does not need be a storage element, but instead may function as an add-in feature connecting cigar band recognition application 130 to a remote network device (not shown) which contains said catalogue of cigar band image data and/or storage of such.

User profile storage 136 can optionally be an integrated feature of data storage 126, and/or, a separate and individual storage element as needed, depending on the operating system in use on client device 100. In an additional embodiment of user profile storage 136, profile storage 136 does not need be a storage element, but instead may function as an add-in feature connecting cigar band recognition application 130 to a remote network device (not shown) which contains said user profile data, for example, user preferences, shopping and/or purchase history, image capture history, and the like.

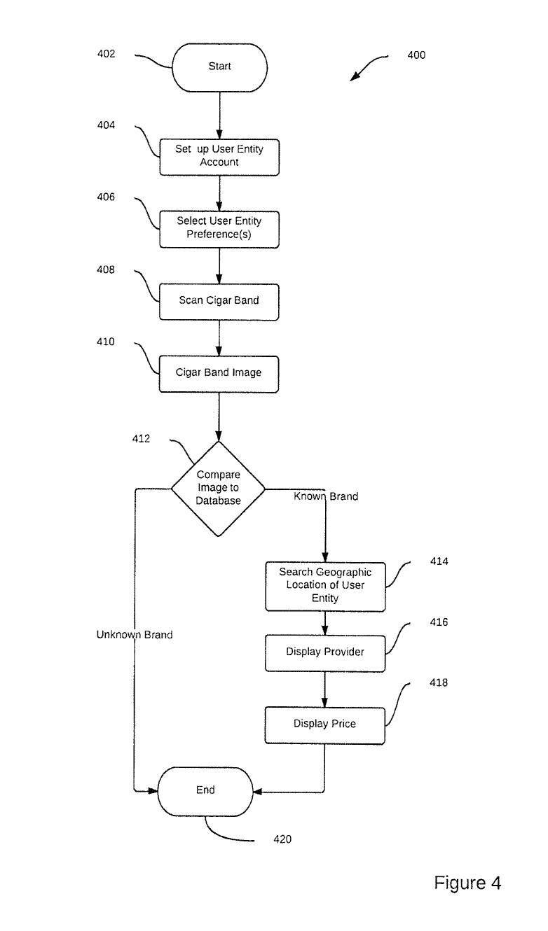

How cigar band recognition application 130 features described herein, specifically elements 132-136, and so such features are operatively instructed by CPU 110 to complete the application tasks, methodology of computer executable instructions, and other general functionality shall be described in greater detail below, in reference to FIG. 4.

Furthermore, applications 128 may include, for example, browser 162 and internet connectivity storage 164. Browser 162 may include virtually any application configured to receive and display graphics, text, multimedia, and the like, employing virtually any web based language. In one embodiment, the browser application is enabled to employ Handheld Device Markup Language (HDML), Wireless Markup Language (WML), WMLScript, JavaScript, Standard Generalized Markup Language (SMGL), HyperTest Markup Language (HTML), eXtensible Markup Language (XML), and the like, to display and send a message. However, any of a variety of other web-based languages may be employed.

In one embodiment, browser 162 may be configured to enable access to a graphical user interface and/or internet connectivity storage 164. In one embodiment, the user interface may be employed by a user of client device 100 to create images, review and/or manage user preferences, and/or other aspects of creating, managing and storing image recognition data.

Client device 100 also includes a power supply 190, one or more network interface 140, an input/output interface 142, a display 144, an image interface 146, an illuminator 147, an audio interface 148, a keypad 150, another haptic interface 152, and an optional global positioning systems (GPS) receiver 154. Power supply 190 provides power to client device 100. A rechargeable or non-rechargeable battery may be used to provide power. The power may also be provided by an external power source, such as an AC adapter or a powered docking cradle that supplements and/or recharges a battery.

Client device 100 may optionally communicate with a base station (not shown), or directly with another computing device. Network interface 140 includes circuitry for coupling client device 100 to one or more networks, and is constructed for use with one or more communication protocols and technologies including, but not limited to, global system for mobile communication (GSM), code division multiple access (CDMA), time division multiple access (TDMA), user datagram protocol (UDP), transmission control protocol/Internetprotocol (TCP/IP), SMS, general packet radio service (GPRS), WAP, ultra wide band (UEB), IEEE 8022.16 Worldwide Interoperability for Microwave Access (WiMax), SIP/RTP, or any of a variety of other wireless communication protocols. Network interface 140 is sometimes known as a transceiver, transceiving device, or network interface card (NIC).

Client device 100 also comprises input/output interface 142 for communicating with external devices, such as a headset, or other input or output devices not shown in FIG. 1. Input/output interface 142 can utilize one or more communication technologies, such as USB, infrared, Bluetooth™, or the like.

Display 144 may be a liquid crystal display (LCD), gas plasma, light emitting diode (LED), or any other type of display used with a computing device. Display 144 may also include a touch sensitive screen arranged to receive input from an object such as a stylus or a digit from a human hand.

Image interface 146 is arranged to produce and receive image data signals, for example, pictures, video, and the like. For example, image interface 146 may include an image recording element (not shown), such as a camera, lens, video, or other image capture element. Image interface 146, can also optionally include an image display element (not shown), for displaying an image created via the image recording element or transmitted to the client device 100. Illuminator 147 may remain provide a status indication and/or provide light. Illuminator 147 may remain active for specific periods of time or in response to events. For example, when illuminator 147 may backlight these buttons in various patterns when particular actions are performed, such as dialing another client device. Illuminator 147 may also cause light sources positioned within a transparent or translucent case of the client device to illuminate in response to actions.

Audio interface 148 is arranged to produce and receive audio signals such as sound of a human voice. For example, audio interface 148 may be coupled to a speaker and microphone (not shown) to enable telecommunication with other and/or generate an audio acknowledgement for some action.

Keypad 150 may comprise any input device arranged to receive input from a user. For example, keypad 150 may include a push button numeric dial, or a keyboard. Keypad 150 may also include command buttons that are associated with selecting and sending images. Optionally, keypad 150 may a visual display feature integrated into display 144, and/or be an application 128 which operates as described above. Haptic interface 152 may be employed to vibrate client device 100 in a particular way when another user of a computing device is calling, an image is received, or for use with any other functionally necessary feature as required.

Optional GPS transceiver 154 can determine the physical coordinates of client device 100 on the surface of the Earth, which typically outputs a location as latitude and longitude values. GPS transceiver 154 can also employ other geo-positioning mechanisms, including, but not limited to, triangulation, assisted GPS (AGPS), E-OTD, CI, SAT, ETA, BSS or the like, to further determine the physical location of client device 200 on the surface of the Earth. It is understood that under different conditions, GPS transceiver 154 can determine a physical location within millimeters for client device 200; and in other cases, the determined physical location may be less precise, such as within a meter or significantly greater distances. In one embodiment, however, mobile device may through other components, provide other information that may be employed to determine a physical location of the device, including for example, a MAC address, IP address, or the like.

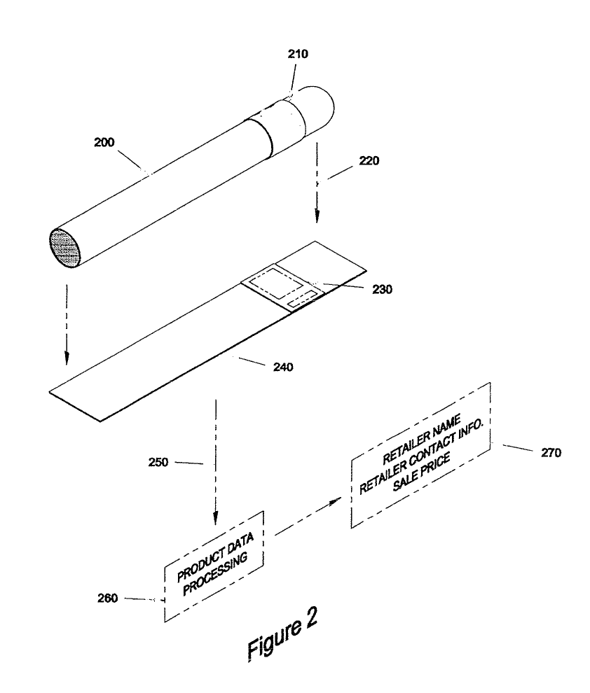

FIG. 2 illustrates one embodiment of creation a cigar band image. A cigar band image is created, first from a scanned image of the cigar band artwork. It is assumed, for purposes of the written description of the general illustration embodied by FIG. 2, that the cigar band scan/image capture device is not illustrated.

Cigar 200 is a consumer product of which cigar band artwork is an integral element. A cigar is a tightly-rolled bundle of dried and fermented tobacco that is ignited so that its smoke may be drawn into the mouth. consists of three parts: the wrapper, binder and filler. The wrapper is the outside leaf—it is what is seen when a person looks at a cigar. Its color and texture are the physical embodiment of the cigar's character and it provides 30% to 60% of the cigar's flavor. The binder is the “blanket” that holds the filler leaves in place and separates them from the wrapper. If the wrapper is removed from a cigar, the next leaf would be the binder. It is used for two purposes: to provide a smooth service for adhering the wrapper, and also for its combustibility, to ensure that the cigar burns well.

The filler tobaccos are the innermost leaves of a cigar that are held together by the binder. Filler tobacco is the “heart” of a cigar, and consists of a carefully blended recipe of different tobaccos—often from different countries—designed to complement the flavor of the wrapper.

The cap is a small piece of tobacco that is cut from the wrapper so that the colors will match, and is applied over the “head,” or the closed end of the cigar that you will ultimately clip. Its purpose is to give the cigar a finished look and to help keep the wrapper from unraveling.

A common way, for example, to categorize cigars is by their shape and size. For many years, the cigar industry has been using terms such as Corona and Panatela, which correspond to the approximate length and width of the cigar, not the manufacturer or brand. Although most manufacturers use commonly accepted size names to describe their cigars, the actual size of a particularly named cigar can vary among manufacturers. In addition cigars are now available in many more dimensions that were available the past, and many manufacturers have created their own names for certain sizes. It is not too uncommon to find two cigars of the same size, made by different companies that have different names to describe the size. Therefore, an incident need for the subject invention has arisen as one product to assist a cigar consumer and/or user to determine not only what brand a cigar is, but also what type a cigar is.

After tobacco is harvested, it undergoes the air curing process, which lasts approximately thirty (30) days. During this time, the tobacco may be, for example, hung in wooden sheds or barns, where the leaves are slowly dried to reduce their moisture content and release their natural sugars. During this time, the leaf color changes as well, from green, to yellow to orange and ultimately to brown. Once the leaves are brown and the edges begin to curl slightly, the tobacco has completed the air curing process.

Curing may be done naturally, in one example, however, curing may also occur through a process with charcoal, wood, propane or natural gas as heat source. Wrapper tobacco is most commonly cured in closed barns or sheds to protect it from the sun, rain and wind. Tobacco used for filler and binder is often cured in sheds with slats or doors that are open for airflow. After the curing process is completed, tobacco leaves are taken down from the shed, packed and shipped to the appropriate location for fermentation, which is customized according to the type of leaf.

Fermentation is a natural process, during which the leaf continues to ripen and the nicotine content diminishes. In addition, leaf characteristics such as the aroma, flavor and color are further developed during this process, according to pre-determined standards that we actually control as the tobacco ferments.

During fermentation, the leaves may be piled into what is called a bulk which is essentially stacks of cured tobacco covered in burlap to retain moisture. A bulk contains anywhere from 4,000 to 5,000 pounds of tobacco, generally, depending on its type. The combination of the remaining water inside the leaf and the weight of the tobacco generates a natural heat which ripens the tobacco. The temperature in the center of the bulk is monitored daily. Every week, the entire bulk is opened. The leaves are then removed to be shaken and moistened and the bulk is rotated so that the inside leaves go outside and the bottom leaves are placed on the top of the bulk. This ensures even fermentation throughout the bulk.

The additional moisture on the leaves, plus the actual rotation of the leaves themselves, generates heat, releasing the tobacco's natural ammonia and reducing nicotine, while also deepening the color and improving the tobacco's aroma. The fermentation process may continue for up to six (6) months, depending on the variety of tobacco, stalk position on the leaf, thickness and intended the use of leaf, whether for wrapper, binder or long filler.

After fermentation, the leaves are sorted manually, leaf by leaf. Wrappers are sorted into several grades, by stalk position on the leaf, as well as by texture, color and the length of the leaf. This is extremely labor intensive as the wrapper leaf represents the outer part of the cigar and has to be perfect in terms of color uniformity, free of blemishes or tears and it must have fine veins. Sorting filler tobacco is relatively more simplistic, as this tobacco is sorted into just three or four categories. Sorting for the binder is based on texture. Before the tobacco can be sorted, it must first be conditioned. During conditioning, the leaves are sprayed with water to increase their moisture content. This makes the leaf pliable so it can be further processed without causing bruising or damage.

After fermentation is complete, tobacco undergoes a secondary aging process where it continues to release ammonia. This enhances the flavor and aroma. Wrapper tobacco may be packed in bales and is left to rest and age for a minimum of two years, for example. During this time, the bales are cared in special warehouses where the humidity and temperature are controlled at all times, in order to maintain the proper moisture and humidity.

Once fermented, filler tobacco goes back to the tobacco floor where part of the mid stem is removed by hand. After the mid stem is removed, filler tobacco is packed in bales and placed into tercios, which are bales made of royal palm bark. Tercios may be an expensive process because each tercio should generally be made by hand. This method originated in Cuba and commonly used because it allows the tobacco to age in a slow, continuous manner to achieve the optimal taste, aroma and burning capability. Filler tobacco remains in tercios for up to two years. Once this is complete, the filler tobacco is often then packed into rum barrels where it continues to age and mature, taking on additional flavor nuances.

The central vein of the tobacco is removed completely with wrapper tobacco and binder, and as mentioned before, it is partially removed for filler tobacco. This is called stripping and it can be done either by hand or machine. Regardless of the type of tobacco, before this can be done, the tobacco has to be conditioned, or re-humidified to the appropriate moisture level. The leaf must be very elastic in order to remove the mid-stem, or else it will be damaged.

After the stem is removed, tobacco goes to selecting. Leaf selection is a work of art, performed by very skilled artisans who are trained to have a keen eye. They must be able to sort each and every leaf based on the requirements of each cigar brand, and also by size, texture, color, color uniformity, vein color and appearance, position of secondary veins and whether the leaf is a “right” or “left.”

Before the filler tobacco can be made into the blend, its moisture content must be optimal. This is an extremely important factor in ensuring that every cigar is of the highest quality. For example, filler with high humidity will result in a cigar with a tight draw. Filler with very low humidity will break the leaf, rendering it unacceptable.

Once the filler is brought to the desired moisture content, it is taken to the blending room. Here is where each blend is put together, using several tobacco types according to a precise recipes created for each cigar brand. Here, each leaf is selected by hand and placed in the appropriate compartment of a wooden box which contains all of the leaves needed to make the recipe of each particular cigar brand. The specialized blend, or recipe, is what provides the cigar's unique flavor and strength. It's important to note that assembling the blend should not be confused with the artistry and skill required to create the actual blend.

The art of cigar making starts with bunching, and to this day, we still use the oldest method for achieving the highest quality finished cigar. This is called the entubarmethod. This technique consists of making a tube with each individual leaf prior to bunching all of the leaves together. This assures that the cigar will burn evenly and also will have a steady and desirable air flow.

Once the bunch is made, the buncher then covers the filler with the appropriate binder leaf which is also predetermine according to each brand's recipe. The bunch, or “naked” cigar is placed into a wood or plastic mold which is put into a bunch press where it receives even pressure in order to give the bunch the desired shape. After pressing is complete, the bunch is completely formed, with the proper ring gauge and shape.

Before the wrapper can be applied, we test each and every bunch to ensure that it will have an even draw. This is called draw testing. Each bunch that passes the draw test is given from the buncher to his or her teammate who will then apply the wrapper. The rollers inspect each wrapper leaf and choose the best part, which they sliced by hand with a half-moon-shaped blade called a chaveta. The roller then stretches the wrapper carefully around the body of the bunch, taking great care to ensure that the leaf is tight to the bunch from the foot to the head of the cigar, using a natural vegetable glue to hold the wrapper in place. The last and most difficult aspect of cigar rolling is applying the cap. Once the cap is intact, the roller inspects the cigar to make sure it has been perfectly rolled. Each cigar is then inspected by specially trained experts who take great care to ensure that the cigar is perfectly formed, and that it has the proper amount of tobacco.

After cigars are aged, they need to be color graded. There are about a number of basic color classifications, and more shade categories. The graders, called seleccionadoras, should be able to recognize them all. Commonly, one seleccionadora sorts all the cigars in a batch by color and shade for each box of cigars. Also commonly, the cigars are arranged so that the darkest is on the left, the lightest on the right. Once the cigars have been color graded, they are ready to have their bands delicately applied.

Cigar 200 further comprises cigar band 210, comprising cigar band artwork which entails the cigar band artwork. For many cigar smokers, the small paper band encircling their stogy is just a piece of trash, to be discarded along with the shrinkwrap around the box. But for others that cigar band is a bit of history—a collectible that adds immeasurably to the romance and mystique of smoking.

Cigar band artwork originated in 19th-century Cuba, when that island nation had already come to be recognize as the cigar capital of the world. At that time cigar packaging was minimal—often no more than a wooden barrel or box, with the manufacturer's name inscribed. The cigars themselves were generally left blank. This situation, not surprisingly, created a cheat's paradise, in which cheap European cigars were bundled in boxes with “Cuban” markings on them and sold, domestically, to unsuspecting customers who thought they were getting fine imported Cubans.

Gustave Bock, a Dutch immigrant who owned a cigar factory in Cuba in the 1830s, is credited with being the first to place a paper band around his cigars. Many other makers adopted this practice, to the point where, by 1855, most Cuban cigar exporters were using them. These bands cut down on instances of counterfeiting while giving cigar manufacturers a way to increase name recognition and loyalty.

The practice spread from Cuba to cigar makers everywhere, and its popularity was encouraged by breakthroughs in printing technology, which developed alongside changes in the economy of Europe and the Americas that favored cigar smoking. Specifically, cheap color printing (through chromolithographic processes developed in Germany) was made widely available during the latter part of the century, and paper-embossing followed in the 1880s.

Between the expansion of the cigar industry and the new possibilities developed by the printing industry, a “Golden Age” of cigar advertising was almost guaranteed, and that's what followed. Cigar makers began working not only to manufacture their cigars, but to differentiate their products from others. The late 19th and early 20th centuries featured elaborate, distinctive cigar box and cigar band artwork, often produced by highly-regarded commercial artists. These well-wrought bands featured images of famous figures of the day, historical figures, nationalistic imagery, nature scenes and animals. As with today's postage stamps, special bands would be made to commemorate special events.

And, also like stamps, the bands had that combination of ephemerality and workmanship that so often draws collectors. While they were often well-made, they weren't intended to last—so they gave collectors a challenge, as baseball cards, comic books and cheap children's toys would later in the 20th century. And they always gave off a whiff of nostalgia, reminding dedicated smokers of good times shared with a cigar and a friend.

Children also found these bands attractive, since they were often left discarded on streets during the height of cigar-smoking's popularity. Manufacturers even made “albums” with blank pages in which a person's cigar band collection could be displayed—the forerunner of those plastic display sheets that every sports-card collector knows so well.

Adding to the boom in band collecting, some cigar makers gave premiums to customers who turned in a certain number of bands—everything from a set of children's silverware (50 bands) to a Scientific American subscription (600 bands) to a baby grand piano (180,000), according to the American Cigar Co. catalog of 1904. (Those of you who used to collect Marlboro Miles during the 1990s should be feeling deja vu right about now.)

After World War I, cigars fell in popularity relative to cigarettes. Cigar makers stopped putting as much energy into the production of attractive cigar bands, as it became more necessary to cut costs. Cigar bands—at least in the US—grew generic, boring. The cost cut wasn't enough—many thousands of cigar companies closed up shop for good in the US during the '20s and '30s.

Band collecting continues in the US among a hardy group mostly consisting of old-timers and nostalgia buffs, but in Europe it remains a thriving hobby, and cigar makers there continue to print colorful but cheap bands, some of which come as part of a series (again like stamps), others of which are created specifically for collectors.

FIG. 2, at 220, illustrates one exemplary embodiment of haar-like image recognition, specifically where it relates to flattening of an image of a cigar band 230. Haar-like features are digital image features used in object recognition. A Haar-like feature considers adjacent rectangular regions at a specific location in a detection window, sums up the pixel intensities in each region and calculates the difference between these sums. This difference is then used to categorize subsections of an image. In one illustrative example, an image database contains a series of human faces. Generally, it can be assumed that it is a common observation that among all faces the region of the eyes is darker than the region of the cheeks. In this illustrations, a common Haar-like feature for face detection is a set of two adjacent rectangles that lie above the eye and the cheek region. The position of these rectangles may be, for example, defined relative to a detection window that acts like a bounding box to the target object, in this example, the face. In the detection phase, a window of the target size is moved over the input image, and for each subsection of the image the Haar-like feature is calculated. In this illustrative example, this difference is then compared to a learned threshold that separates non-objects from objects. Because such a Haar-like feature is a weak learner or classifier, generally, for example, its detection quality is slightly better than random guessing, a large number of Haar-like features are necessary to describe an object with sufficient accuracy. Haar-like features are, generally speaking, therefore organized in something called a classifier cascade to form a strong learner or classifier. The key advantage of a Haar-like feature over most other features is its calculation speed. Due to the use of integral images, a Haar-like feature of any size can be calculated in constant time (approximately 60 microprocessor instructions for a 2-rectangle feature).

A cascade classifier can be defined as consisting of set of stages, where each stage is an ensemble of weak learners. The weak learners are simple classifiers which may also be called decision stumps. Each stage may be, for example, trained using a technique called boosting. Boosting may be defined as providing the ability to train a highly accurate classifier by taking a weighted average of the decisions made by the weak learners.

Each stage of the classifier labels the region defined by the current location of the sliding window as either positive or negative. Positive may, for example, indicate that an object was found and negative, in another example, may indicate that no object. In one exemplary illustration, if the label is negative, the classification of this region may be complete, and the detector may slide the window to the next location. In another exemplary illustration, if the label is positive, for example, the classifier may pass the region to the next stage. In these illustrations, the detector may, for example, report an object found at the current window location when the final stage classifies the region as positive.

The stages may be designed, for example, to reject negative samples as fast as possible. The assumption here may be, for example, that the vast majority of windows do not contain the object of interest. Conversely, true positives may be rare, and worth taking the time to verify. A true positive occurs, by way of explanatory definition, when a positive sample is correctly classified. A false positive occurs, also by way of explanatory definition, when a negative sample is mistakenly classified as positive. A false negative may occur, for example, when a positive sample is mistakenly classified as negative. In one preferred exemplary embodiment, each stage in the cascade must have a low false negative rate. If a stage incorrectly labels an object as negative, the classification stops, and there is no way to correct the mistake. However, each stage may have a high false positive rate. Even if it incorrectly labels a nonobject as positive, the mistake can be corrected by subsequent stages.

The overall false positive rate of the cascade classifier may be defined as fs, where f is the false positive rate per stage in the range (0 1), and s is the number of stages. In another illustrative example, the overall true positive rate may be defined as ts, where t is the true positive rate per stage in the range (0 1). Therefore, in one preferred embodiment, adding more stages may reduce the overall false-positive rate, but also may reduce the overall true positive rate.

FIG. 2, therefore illustrates one exemplary embodiment illustrating the physical manifestation of the defined haar-like features and cascade qualifiers discussed above, as applied to a cigar band artwork element 210. An illustrative system (not shown), which may produce the results illustrated in FIG. 2 may include any, all or none of the elements and components as described with reference to FIG. 1, but for illustrative purposes only here may further include a device having a processor, a memory, one or more input peripherals, one or more output peripherals, a network connection, and one or more remote computers. The illustrative device can be, for example, a smartphone or a tablet computer, although any other consumer electronic device can be used. The processor can comprise a microprocessor, and its operation may be controlled, in part, by information stored in the memory, such as operating system software, application software (e.g., “apps”), data, etc. The memory may comprise flash memory, a hard drive, etc. In this illustrative system, the input peripherals may include a camera and/or a microphone. The peripherals (or device itself) may also comprise an interface system by which analog signals sampled by the camera/microphone are converted into digital data suitable for processing by the system. Other input peripherals can include a touch screen, keyboard, etc. The output peripherals can include a display screen, speaker, etc. The network connection can be wired (e.g., Ethernet, etc.), wireless (WiFi, 4G, Bluetooth, etc.), or both.

In an exemplary operation which may result in the components as shown in FIG. 2, a device may receive a set of digital content data, such as through a camera, a microphone and/or interface, through the network connection, or otherwise. The content data may be of any type; video, still photography, and audio are non-limiting examples.

The system may process the digital content data to generate corresponding identification data. This may be done, e.g., by applying a digital watermark decoding process, or a fingerprinting algorithm-desirably to data representing the sonic or visual information itself, rather than to so-called “out-of-band” data (e.g., file names, header data, etc.). The resulting identification data serves to distinguish the received content data from other data of the same type (e.g., other still photographs, other audio, or other video).

By reference to this identification data, the system determines corresponding software that should be invoked. In one example, for illustration purposes, the software application that may be invoked is the one described in the claims below as an operation of the processor, whereby the resulting identification data distinguishes the received content data as that of a cigar band artwork. One exemplary method of determining corresponding software may be, for example, by indexing a table, database, or other data structure with the identification data, to thereby obtain information identifying the appropriate software. This determination and/or invocation will be discussed in further detail with reference to FIG. 4.

The resultant image created by the haar-like image recognition method described herein is flattened cigar band artwork 230.

Communication methods 250 (methods specifically not illustrated) allow for the flattened cigar band artwork image 230 to be compared with remote database of cigar brands (also not shown). Communication 250 methods may include those described with reference to FIGS. 1 and 3, may also include a wired network method, a wireless network method, or any combination thereof, non-limited by any functionally reasonable communication method.

Comparison and product data processing 260 of flattened cigar band artwork 230 with catalogue of similar cigar band artwork to determine brand, retailer and price may occur, for example, through embodiments and methods as described below with reference to FIG. 5.

Display 270 illustrates one embodiment of a physical display of the resultant determined cigar brand, retailer contact info and sale price. Display may include a digital display or otherwise as required by a device upon which said display 270 is viewed. Said display, may be, for example, an audio tone speaking out the information, a series of images signifying the information, or other display as reasonably functional of the operative term display. Additionally, other features are contemplated to be can be displayed, at user option of customer, for example, history of the brand, history of the artwork, images of production facilities, list of ingredients, type of tobacco leaves, etc.

FIG. 3 illustrates one embodiments of an environment in which the inventive cigar band recognition interface may be practiced. Not all the components may be required to practice the invention, and variations in the arrangement and type of the components may be made without departing from the spirit or scope of the invention. As shown in FIG. 4, system 300 includes network 410, wireless network 420, user devices 430, and the cigar band recognition interface 440.

Network 310 can be configured to couple user devices 330 with other computing devices, including the cigar band recognition interface 340 directly to user devices 330, to and through wireless network 320 to user devices 330 and through wireless network 320 to other network enabled devices. Network 310 can be enabled to employ any form of computer readable media for communicating information from one electronic device to another. Also, network 310 can include the Internet in addition to local area networks (LANs) and wide area networks (WANs), direct connections, such as, for example, through a universal serial bus (USB) port, other forms of computer-readable media, or any combination thereof. On an interconnected set of LANs, including those based on differing architectures and protocols, a router acts as a link between LANs, enabling data communication to be sent from one to another. In addition, data communication links within LANs typically include twisted wire pair or coaxial cable, while data communication links between networks may utilize analog telephone lines, full or fractional dedicated digital lines including T1, T2, T3 and T4, Integrated Services Digital Networks (ISDNs), Digital Subscriber Lines (DSLs), wireless links including, but not limited to satellite links, or other communications links known to those skill in the art. Furthermore, remote computers and other related electronic devices could be remotely connected to either LANs or WANs via a modem and temporary telephone link. In essence, network 410 includes any communication method by which information may travel between computing devices.

Wireless network 320 can be configured to couple user devices 430 and their components with network 310. Wireless network 320 can included any of a variety of wireless sub-networks that may feature overall stand-alone ad-hoc networks, and the like, to provide an infrastructure-oriented connection for user devices 330. Such sub-networks may include mesh networks, wireless LAN (WLAN) networks, cellular networks, and any other format of wireless connection.

Wireless network 320 can further include an autonomous system of terminals, gateways, routers, and the like connected by wireless radio links, and similar. These connectors can be configured to move freely and randomly and organize themselves arbitrarily, such that the topology of wireless network 320 may change rapidly.

Wireless network 320 may further employ a plurality of access technologies including second (2G), third (3G) generation radio access for cellular systems, Code Division Multiple Access (CDMA), WLAN, Wireless Router (WR) mesh, and similar configurations. Access technologies such as 2G, 3G and future access network may enable wide area coverage for mobile devices, such as embodiments of user devices 330, with various degrees of mobility. For example, wireless network 320 may enable a radio connection through a radio network access such as Global System for Mobil Communication (GSM), General Packet Radio Services (GPRS), Enhanced Data GSM Environment (EDGE), Wideband Code Division Multiple Access (WCDMA), and similar. In essence, wireless network 320 may include virtually any wireless communication mechanism by which information may travel between user entity devices 330 and another computing device, network or similar.

One embodiment of a user device 330 is described in more detail above, in conjunction with FIG. 1. Generally, however, user devices 330 may include virtually any portable computing device capable of receiving and sending data over a network, such as network 310 and wireless network 320. User devices 330 may also be described generally as a user device that is configured to be portable. Thus, user devices 330 may include virtually any portable computing device capable of connecting to another computing device and receiving information. Such devices include portable devices, for example, mobile phones, smartphones, display pages, Radio Frequency (RF) devices, Infrared (IR) devices, Near Frequency Communication (NFC) devices, Personal Digital Assistants (PDAs), handheld computers, tablets, laptop computers, wearable computers, computer peripheral accessories, integrated devices combining one or more of the preceding devices, and the like. As such, user devices 430 typically range widely in terms of capabilities and features. For example, a mobile phone may have a numeric keypad and a few lines of monochromatic LCD display on which only text may be displayed. In another example, a web-enabled mobile device such as a tablet may have a touch sensitive screen, a stylus and several lines of color LCD display in which both text and graphics can be displayed.

User devices 330 may include virtually any computing device capable of communicating over a network to send and receive information, including communicating cigar band image information, performing various online activities, including trading data with other user entity devices, and similar. The set of such devices that can be used for user devices 330 include devices that typically connect using a wired or wireless communications mediums, such as, for example, personal computers, multiprocessor systems, microprocessor-based or programmable consumer electronics, network PCs, and the like. In one embodiment, at least some of the user devices 330 can operate over wired and/or wireless networks. User devices 330 can also include virtually device usable as a television device, as many newer models of these devices include a capability to access and/or otherwise communicate over a network such as network 310 and/or wireless network 320. Moreover, user entity devices 430 may access various computing applications, including a browser, cigar band recognition interface, and/or any other web-based application.

A web-enabled user device 330 may include a browser application that is configured to receive and to send web pages, web-based communications, and any other data. The browser application can be configured to receive and display graphics, text, multimedia, and similar functionalities, employing virtually any web-based language, including, but not limited to, a wireless application protocol (WAP) and similar. In one embodiment, the browser application can be enabled to employ Handheld Device Markup Language (HDML), Wireless Markup Language (WML), WML-Script, JavaScript, Standard Generalized Markup Language (SMGL), HyperText Markup Language (HTML), eXtensble Markup Language (XML) and any other programming language that is functionally compatible, to display and send information. In one embodiment, a user of the user device 430 can employ the browser to perform various activities over a network, however, another application besides the browser can also be used to perform various online activities.

User devices 330 can also include at least one other user application that is configured to send and receive content from and to another computing device. The user application can include a capability to provide and receive textual content, graphical content, audio content, and any other type of transmittable information. The user application can further provide information that identifies itself, including, but not limited to, a type capability, name and any other functionally necessary descriptive information. In one embodiment, user devices 430 can uniquely identify themselves through any of a variety of mechanisms, for example, including but not limited to, a phone number, Mobile Identification Number (MIN), an Electronic Serial Number (ESN), a Global Positioning System (GPS) identifies, or other mobile device identifier. In additional embodiments, the information can also indicate a content format that the mobile device is enabled to employ. For example, such information can be provided in a network packet, or any other data transmission format, sent the cigar band recognition interface 350 or any other interface. Such end-user account, for example, can be configured to enable the end-user to manage one or more online activities, including, for example, but not limited to, search activities, browsing of various websites, making purchases, selling products/services, communicating with others and otherwise engaging in online activities. However, participation in such online activities can also be performed without logging into an end-user account.

In further embodiments of the present system, user devices 330 have the option to include peripheral devices, which may be, for example, virtually any computing and/or receiving device capable of receiving communicating over a network, including receiving image recognition information, performing various online activities, including receiving data from other user devices, peripherals and similar. The set of such devices that can be used for user peripheral devices include devices that typically connect using a wired or wireless communications mediums, such as, for example, microprocessor-based or programmable consumer electronics, and the like. In one embodiment, at least some of the user peripheral devices can operate over wired and/or wireless networks. These devices can include, for example, but are not limited to, mobile phones, smartphones, display pagers, Radio Frequency (RF) devices, Infrared (IR) devices, Near Frequency Communication (NFC) devices, Personal Digital Assistants (PDAs), handheld computers, tablets, laptop computers, wearable computers, general computer peripheral accessories, integrated devices combining one or more of the preceding devices, and the like. User peripheral devices can also include virtually device usable as a television device, as many newer models of these devices include a capability to access and/or otherwise communicate over a network such as network 310 and/or wireless network 320. Communications to these devices can occur using networks and/or methods as described above.

Communication media typically embodies computer-readable instructions, data structures, program modules, or other transport mechanism and includes any information delivery media. By way of example, and not in limitation, communication media can include wired media such as twisted pair, coaxial cable, fiber optics, wave guides, and other wired media and wireless media such as acoustic, Radio Frequency (RF), Near Frequency Communication (NFC), infrared, and other wireless media.

One embodiment of cigar band recognition interface 340 is described in more detail above, in conjunction with FIGS. 1-3. Briefly, cigar band recognition interface 340 may include any one or more computing devices capable of connecting to network 310 to enable user devices 330 to communicate between each other. In one embodiment, cigar band recognition interface 340 can further enable one or more users of user devices 330 to access and/or download a cigar band recognition interface application for use on the user devices 330. In one embodiment, the cigar band interface application is configured to enable a user to create cigar band images, provide various user preferences and settings, create a user profile, create notes, and share information to other users. When configured, cigar band recognition interface 440 may then employ one or use of the cigar band images to index and catalogue the cigar band image in reference to a specific cigar brand and/or manufacturer. In one embodiment, the data collected for indexing and cataloguing can be stored on user devices 330, however, in another embodiment, the data may be stored at least in part on cigar band recognition interface 3500, cloud-based storage platforms, and/or any other functionally compatible storage medium.

The operation of certain aspects of the invention will now be described with respect to FIG. 4. FIG. 4 illustrates a logical flow diagram generally showing one embodiment of a process for using scanning a cigar band to determine a cigar brand and at least one purchase modality through the devices and systems described above. As noted elsewhere, process 400 of FIG. 4 can be implemented in part, or whole, within network device 330 of FIG. 3, and/or one or more of the user entity devices 100 of FIG. 1. Furthermore, it is contemplated that steps be added and/or removed from Process 400. The following detailed description is, therefore, not to be taken in a limiting sense, and various embodiments envisioned by adding and/or removing steps in the process may be readily combined, without departing from the scope or spirit of the invention. Additionally, the written description below pre-supposes that a user of the process will be in such a location that a cigar is available for scanning, for example, a store which sells cigars, a cigar bar, or any other location that a cigar may be readily available to a user.

Process 400 begins after a start block 402, at 404, where a user entity sets up a user entity identity and/or account. An online identity, internet identity, or internet persona is a social identity that an Internet user establishes in as an user identification for billing and product order history, for example, but also for other purposes, including but not limited to, identities for online communities and account-based websites. It can also be considered as an actively constructed presentation of oneself. Although some users prefer to use real names online, some Internet users prefer to be anonymous, identifying themselves by means of pseudonyms, which reveal varying amounts of personally identifiable information. An online identity may even be determined by a user's relationship to a certain social group they are a part of online. Some can even be deceptive about their identity.

In some online contexts, including Internet forums, online chats, and massively multiplayer online role-playing games (MMORPGs), users can represent themselves visually by choosing an avatar, an icon-sized graphic image. Avatars are one way users express their online identity. As other users interact with an established online identity, it acquires a reputation, which enables them to decide whether the identity is worthy of trust. Some websites also use the user's IP address to track their online identities using methods such as tracking cookies. At 504, it is contemplated that a user identification account may be created by a user, for example, along with the creation of an avatar that has the option to be cigar artwork-related. Further embodiments are contemplated where avatars of a user may be, for example, user representations in a virtual setting, such as a virtual cigar shop or cigar bar. Additional illustrative examples may also include, as an example, an avatar or user name displayed as part of a live feed and/or chat portal which allows for real-time multi-party communication while purchasing and/or researching cigar brands.

At 404, the user has the option of creating a user account according to many methods and embodiments. For example, upon downloading an application to a mobile device, the user can be prompted to create the user account, update an existing using account, and/or bypass a user account and accessing the application content as a guest. However, in a preferred embodiment, a user would need a user account to at least store shipping and/or billing information for items purchased or viewed through the application. Additional embodiments include the option for a user entity to use a laptop computer or desktop computing device to log onto a website using a browser application, and thereby creating an account through a similar method however different the interface content and/or request methods are. Additional methods and embodiments envisioning a user entity creating and/or changing, editing and/or otherwise managing a user account in any manner that is reasonably compatible with the incident description herein.

At 406, a user has the option to select at least one user entity preference, to include with their user entity account and/or online identity. User entity preferences are the user options for predilections of choice interests, including, for example but not limited to, how the application may be displayed across multiple devices, an avatar, billing preferences, shipping preferences, and the like. In additional embodiments contemplated, user entity preferences may include a number of feature settings, for example, additional at-cost features of the application which may be purchased and/or otherwise downloaded as a function of the application, notes, research history settings, and the like.

Privacy-publicity settings are also determined at 406. Privacy settings can include the option to have a user preference hidden for all search capabilities, for later use or for the personal reference of the user entity. Publicity settings can include the option for all user entity preferences to be searchable at all times, or searchable only during specified periods of times, or as with the privacy settings, not searchable at any time. Additional methods and embodiments illustrating privacy-publicity determinations and options for user entities are further contemplated, in any manner that is functionally compatible with the present description and method.

At 408, a user scans a cigar band to create a cigar band image. Scanning a cigar band may occur through a number of methods which may include, but are not limited to, a user opening an application on a mobile device and accessing a camera feature through the application; opening a camera module or feature directly on a mobile device and scanning a cigar band, or any other functionally necessary method for obtaining a scanned image of a cigar band.

At 408, a system may process a digital content data, for example, a cigar band, to generate corresponding identification data of the fact that the image does in fact contain a cigar band with recognizable artwork. This may be done, e.g., by applying a digital watermark decoding process, or a fingerprinting algorithm-desirably to data representing the sonic or visual information itself, rather than to so-called “out-of-band” data (e.g., file names, header data, etc.). The resulting identification data serves to distinguish the received content data from other data of the same type (e.g., other still photographs, other audio, or other video).

In one embodiment, through reference to this identification data, the system determines corresponding software and/or applications that should be invoked. In one example, for illustration purposes, the software application that may be invoked is the one described in the claims below as an operation of the processor, whereby the resulting identification data distinguishes the received content data as that of a cigar band artwork. One exemplary method of determining corresponding software may be, for example, by indexing a table, database, or other data structure with the identification data, to thereby obtain information identifying the appropriate software.

In some instances the data structure may return identification of a single software program. In that case, this software is launched-if available. Availability does not require that the software be resident on the device. Cloud-based apps may be available. If not available, the software may be downloaded (e.g., from an online repository), installed, and launched. Further embodiments are contemplated where the device can subscribe to a software-as-service cloud version of the app. Involvement of a user in such action(s) can depend on the particular implementation; sometimes the user is asked for permission; in other implementations such actions proceed without disturbing the user.

In further exemplary embodiments of scanning a cigar band at 508, the data structure may identify several different software programs. The different programs may be specific to different platforms, in which case, the device may simply pick the program corresponding to that platform (e.g., Android platform devices, iOs platform devices, etc.). or, the data structure may identify several alternative programs that can be used on a given platform. In this circumstance, the device may check to determine which—if any—is already installed and available. If such a program is found, it can be launched. If two such programs are found, the device may choose between them using an algorithm (e.g., most-recently-used; smallest memory footprint; etc.), or the device may prompt the user for a selection. If none of the alternative programs is available to the device, the device can select and download one—again using an algorithm, or based on input from the user. Once downloaded and installed, the application is launched.

Further embodiments are contemplated where a software in the device may strictly enforce the content-identified software selection. Alternatively, the system may treat such software identification as a preference that the user can override. In some implementations the user may be offered an incentive to use the content-identified software. Or, conversely, the user may be assessed a fee, or other impediment, in order to use software other than that indicated by the content.

It should be understood that the software indicated herein throughout this detailed description and the claims may be a stand-alone app, or a software component—such as a codec, driver, etc. The software can render the content, or it can be a content companion—providing other information or functionality related to the content. In some implementations the “software” can comprise a URL, or other data/parameter that is provided to another software program or online service (e.g., a YouTube video identifier).

In accordance with a further aspect of the present technology, operating system software is provided to perform one or more services specific to content processing or identification. In one particular implementation, an OS application programming interface (API) takes content data as input (or a pointer to a location where the content data is stored), and returns fingerprint data corresponding thereto. Another OS service (either provided using the same API, or another) takes the same input, and returns watermark information decoded from the content data. (An input parameter to the API can specify which of plural fingerprint or watermark processes is to be applied. Alternatively, the service may apply several different watermark and/or fingerprint extraction processes to the input data, and return resultant information to the calling program. In the case of watermark extraction, the resultant information can be checked for apparent validity by reference to error correction data or the like.)

The same API, or another, can further process the extracted fingerprint/watermark data to obtain XML—based content metadata that is associated with the content (e.g., image data, color classification, etc.).

Such a content-processing API can establish a message queue (e.g., a viewing queue) to which results of the fingerprint/watermark extraction process (either literally, or the corresponding metadata) are published. When such content is detected, the monitoring app—or another—can launch into activity—logging the event, acting to complement the media content, offering a buying opportunity, etc. Alternatively, such functionality can be implemented apart from the operating system. One approach is with a publish/subscribe model, by which some apps publish capabilities (e.g., listening for a particular type of audio), and other subscribe to such functions. By these arrangements, loosely-coupled applications can cooperate to enable a similar eco-system.

From the foregoing, it will be recognized that certain of the foregoing embodiments ease the user's dilemma of locating an app associated with cigar band artwork image content, as contemplated by this application. However, the media content serves to locate its own favored apps. Such embodiments assure continuity between a purpose of the application and the ease of use and delivery to the user. For example, these embodiments optimize the experience that the art is intended to create, i.e., easily determine and learn about a particular cigar maker and easily obtain buying information for such.

Furthermore, this technology may also foster competition in the cigar marketplace—giving graphic designers and artists a more prominent placement in the purchase of cigars, bringing back one of the original traditions of such artistically created cigar band images. Desirably, a Darwinian effect may emerge, by which app popularity becomes less an expression of branding and marketing budgets, and more a reflection of popularity of the content thereby delivered.

It should be noted that cigar band image creation is discussed in more detail in reference to FIG. 2, and shall not be further discussed with reference to the method of using such cigar band image to determine a cigar brand.

At 410, the cigar band image which is created by scanning at 408 is used to determine a cigar brand, based on comparison of said resultant cigar band image to a database of stored, indexed and catalogued cigar brands. The database of cigar brands may be, by way of non-limiting example, stored in a remote, off-site repository such as illustrated in FIG. 1. The database may also be cloud-based. Additional embodiments of the storage location further include, but are not limited to, regional databases located in generally demarcated regions so as to limit delivery and/or purchase modality locations; international as compared to domestic databases stored based on cloud-based providers varying by country; or any other functionally compatible storage location which reasonably enables the comparison of a cigar band image to a database of known cigar brands.

In one exemplary embodiment, term indexing can be defined as the task of creating an index of terms and clauses into a collection. In one example, many operations in automatic theorem provers require search in huge collections of terms and clauses. Such operations typically fall into the following exemplary scheme: Given a collection S of terms (clauses) and a query term (clause) q, find in S some/all terms t related to q according to a certain retrieval condition. Most interesting retrieval conditions are formulated as existence of a substitution that relates in a special way the query and the retrieved objects t. Here is a list of retrieval conditions frequently used in provers: term q is unifiable with term t, i.e., there exists a substitution θ, such that qθ=tθ; term t is an instance of q, i.e., there exists a substitution θ, such that qθ=t; term t is a generalization of q, i.e., there exists a substitution θ, such that q=tθ; clause q subsumes clause t, i.e., there exists a substitution θ, such that qθ is a subset/submultiset of t; and clause q is subsumed by t, i.e., there exists a substitution θ, such that tθ is a subset/submultiset of q.

Term sets, for illustrative purposes herein and in conjunction with the detailed description of this invention, can be defined by cigar brands. Very often the sizes of term sets (further herein also known as brand catalogues) to be searched are large, the retrieval calls are frequent and the retrieval condition test is rather complex. In such situations linear search in S, when the retrieval condition is tested on every term from S, becomes prohibitively costly. To overcome this problem, special data structures, called indexes, are designed in order to support fast retrieval. Such data structures, together with the accompanying algorithms for index maintenance and retrieval, are called term indexing techniques. Classic indexing techniques can include discrimination trees, substitution trees, and path indexing. Modern indexing techniques can include feature vector indexing, code trees, context trees, and relational path indexing.

In path indexing, a term is stored via the set of paths from the root to the leaves. In discrimination tree indexing, a term is stored via a single path representing a fixed-order traversal of the term. Discrimination trees provide faster lookup for many operations and in particular when looking for database terms which can be instantiated to the query term (which is relevant for subsumption). On the other hand, finding terms unifiable with a query term is more complicated since we need to skip and identify subterms in the index.

Relational path indexing, on the other hand, is an extension of the positional indexing. Its functionality is related to quick check: extract a vector of types (of feature values) from a mother (that will become and edge) and from a daughter, and test the unification of the two vectors before attempting to unify the edge and the daughter.

Path indexing differs from quick-check in two major aspects. First, quick check needs statistical training to decide from which nodes to extract the quick check vectors. Path indexing identifies these nodes by a static analysis of grammar rules, performed off-line and with no training required. Second, path indexing is built on top of positional indexing, therefore the vector of nodes used as a pre-test for unification can be different for each pair of mother-daughter that can unify.

The positional indexing has the benefit of allowing for a simple, yet efficient, implementation. Since each daughter is allocated a separate entry in the chart, further information collected about the peculiarities of each mother-daughter pair (with respect to the unification of the respective mother and daughter) can be integrated into the indexing scheme. This is one of the fundamental differences between indexing and filtering, and another reason for preferring indexing over filtering.

Feature vector indexing restricts the selection of features used in an index, a technique which has the option to immediately adapt to indexing modulo arbitrary AC theories with only minor loss of efficiency. Alternatively, in another exemplary example, the feature selection can be restricted to result in set subsumption. Feature vector indexing has been implemented in our equational theorem prover E, and has enabled us to integrate new simplification techniques making heavy use of subsumption. We experimentally compare the performance of the prover for a number of strategies using feature vector indexing and conventional sequential subsumption.

In pattern recognition and machine learning, a feature vector is an n-dimensional vector of numerical features that represent some object. Many algorithms in machine learning require a numerical representation of objects, since such representations facilitate processing and statistical analysis. When representing images, the feature values might correspond to the pixels of an image, when representing texts perhaps to term occurrence frequencies. Feature vectors are equivalent to the vectors of explanatory variables used in statistical procedures such as linear regression. Feature vectors are often combined with weights using a dot product in order to construct a linear predictor function that is used to determine a score for making a prediction. The vector space associated with these vectors is often called the feature space. In order to reduce the dimensionality of the feature space, a number of dimensionality reduction techniques can be employed.

Code trees are a certain category of variable length codes which can be represented by root trees. The structure of the tree defines the coding of the symbols regarded. Code trees consist of interior nodes, leaf nodes and corresponding branches. Leaf nodes do not have a succeeding node and represent symbols, if the tree describes a prefix code. The path from the root to a leaf node defines the code word for the particular symbol assigned to this node.

Normally common compression methods use binary code trees. In that case a left branch represents a binary 0 and a right branch a binary 1. A particular code word will be created by running from the root node to the symbol's leaf node. Any left-sided branch adds a 0 to the code word; every right-sided branch a binary 1. The required number of steps or the depth of this part of the code tree is equal to the code length.

Any node in a binary code tree has only one predecessor and two successors. If symbols are assigned only to leaf nodes and interior nodes only construct the tree, it is always sure that no code word could be the prefix of another code word. Such a tree matches the prefix property. Code trees can be constructed in a way that the probability for the occurrence of the symbols will be represented by the tree structure. Binary trees only allow a graduation of 1 bit. More precise solutions will be offered by the arithmetic code.

The context tree weighting method (CTW) is a lossless compression and prediction algorithm. The CTW algorithm is among the very few such algorithms that offer both theoretical guarantees and good practical performance. The CTW algorithm is an “ensemble method,” mixing the predictions of many underlying variable order Markov models, where each such model is constructed using zero-order conditional probability estimators.

Cataloguing methods and standards involves the resolution of two potentially conflicting forces: provision of information for the ever-developing needs and interests of the scholarly (and, increasingly, the not-so-scholarly community), as reflected in the evolving methods employed in a variety of catalogues of other collections; and in-house styles, conventions, and methods, which cannot lightly be altered or abandoned.

The term “comparisons” in multiple comparisons typically refers to comparisons of two groups, such as a treatment group and a control group. “Multiple comparisons” arise when a statistical analysis encompasses a number of formal comparisons, with the presumption that attention will focus on the strongest differences among all comparisons that are made.

Techniques have been developed to control the false positive error rate associated with performing multiple statistical tests. Similarly, techniques have been developed to adjust confidence intervals so that the probability of at least one of the intervals not covering its target value is controlled. For hypothesis testing, the problem of multiple comparisons (also known as the multiple testing problem) results from the increase in type I error that occurs when statistical tests are used repeatedly. If n independent comparisons are performed, the experiment-wide significance level (x̅, also termed FWER for familywise error rate, is given by (x̅=1−(1−α_{{per comparison}})ⁿ. Hence, unless the tests are perfectly dependent, α increases as the number of comparisons increases. If we do not assume that the comparisons are independent, then we can still say: α̅≦n·α_{{per comparison}}, which follows from Boole's inequality Example: 0.2649=1−(1−0.05)⁶≦0.05×6=0.3

There are different ways to assure that the familywise error rate is at most α̅. The most conservative, but free of independency and distribution assumptions method, is known as the Bonferroni correction α_{{per comparison}}=α̅/n. A more sensitive correction can be obtained by solving the equation for the familywise error rate of n independent comparisons for α_{{per comparision}}. This yields

$${α}_{\{ per comparison \}} = 1 - {( 1 - \overline{α} )}^{\frac{1}{n}} ,$$

which is known as the \check{S}idák correction. Another procedure is the Holm-Bonferroni method which uniformly delivers more power than the simple Bonferroni correction, by testing only the most extreme p value (i=1) against the strictest criterion, and the others (i>1) against progressively less strict criteria. α_{{per comparison}}=α̅/(n−i+1).

Multiple testing correction refers to re-calculating probabilities obtained from a statistical test which was repeated multiple times. In order to retain a prescribed familywise error rate α in an analysis involving more than one comparison, the error rate for each comparison must be more stringent than α. Boole's inequality implies that if each test is performed to have type I error rate α/n, the total error rate will not exceed α. This is called the Bonferroni correction, and is one of the most commonly used approaches for multiple comparisons.

In some situations, the Bonferroni correction is substantially conservative, i.e., the actual familywise error rate is much less than the prescribed level α. This occurs when the test statistics are highly dependent (in the extreme case where the tests are perfectly dependent, the familywise error rate with no multiple comparisons adjustment and the per-test error rates are identical). For example, in fMRI analysis, tests are done on over 100,000 voxels in the brain. The Bonferroni method would require p-values to be smaller than 0.05/100000 to declare significance. Since adjacent voxels tend to be highly correlated, this threshold is generally too stringent.

Because simple techniques such as the Bonferroni method can be too conservative, there has been a great deal of attention paid to developing better techniques, such that the overall rate of false positives can be maintained without inflating the rate of false negatives unnecessarily. Such methods can be divided into general categories: Methods where total alpha can be proved to never exceed 0.05 (or some other chosen value) under any conditions. These methods provide “strong” control against Type I error, in all conditions including a partially correct null hypothesis. Methods where total alpha can be proved not to exceed 0.05 except under certain defined conditions. Methods which rely on an omnibus test before proceeding to multiple comparisons. Typically these methods require a significant ANOVA/Tukey's range test before proceeding to multiple comparisons. These methods have “weak” control of Type I error. Empirical methods, which control the proportion of Type I errors adaptively, utilizing correlation and distribution characteristics of the observed data.

Traditional methods for multiple comparisons adjustments focus on correcting for modest numbers of comparisons, often in an analysis of variance. A different set of techniques have been developed for “large-scale multiple testing”, in which thousands or even greater numbers of tests are performed. For example, in genomics, when using technologies such as microarrays, expression levels of tens of thousands of genes can be measured, and genotypes for millions of genetic markers can be measured. Particularly in the field of genetic association studies, there has been a serious problem with non-replication—a result being strongly statistically significant in one study but failing to be replicated in a follow-up study. Such non-replication can have many causes, but it is widely considered that failure to fully account for the consequences of making multiple comparisons is one of the causes.

A basic question faced at the outset of analyzing a large set of testing results is whether there is evidence that any of the alternative hypotheses are true. One simple meta-test that can be applied when it is assumed that the tests are independent of each other is to use the Poisson distribution as a model for the number of significant results at a given level α that would be found when all null hypotheses are true. If the observed number of positives is substantially greater than what should be expected, this suggests that there are likely to be some true positives among the significant results. For example, if 1000 independent tests are performed, each at level α=0.05, we expect 50 significant tests to occur when all null hypotheses are true. Based on the Poisson distribution with mean 50, the probability of observing more than 61 significant tests is less than 0.05, so if we observe more than 61 significant results, it is very likely that some of them correspond to situations where the alternative hypothesis holds. A drawback of this approach is that it over-states the evidence that some of the alternative hypotheses are true when the test statistics are positively correlated, which commonly occurs in practice

A comparison sort can be a type of sorting algorithm that only reads the list elements through a single abstract comparison operation (often a “less than or equal to” operator or a three-way comparison) that determines which of two elements should occur first in the final sorted list. The only requirement is that the operator obey two of the properties of total order.

:if a≦b and b≦c then a≦c (transitivity), for all a and b, either a≦b or b≦a (totalness or trichotomy). It is possible that both a≦b and b≦a; in this case either may come first in the sorted list. In a stable sort the input order determines the sorted order in this case. A metaphor for thinking about comparison sorts is that someone has a set of unlabeled weights and a balance scale Their goal is to line up the weights in order by their weight without any information except that obtained by placing two weights on the scale and seeing which one is heavier (or if they weigh the same).

Performance limits the advantages of different sorting techniques There are fundamental limits on the performance of comparison sorts. A comparison sort must have a lower bound of (n log n) comparison operations, which is known as linearithmic time. This is a consequence of the limited information available through comparisons alone—or, to put it differently, of the vague algebraic structure of totally ordered sets. In this sense, mergesort, heapsort, and introsort are asymptotically optimal in terms of the number of comparisons they must perform, although this metric neglects other operations. The three non-comparison sorts above achieve O(n) performance by using operations other than comparisons, allowing them to sidestep this lower bound (assuming elements are constant-sized).

Also note that real-world measures of sorting speed may need to take into account the ability of some algorithms to optimally use relatively fast cached computer memory, or the application may benefit from sorting methods where sorted data begins to appear to the user quickly (and then user's speed of reading will be the limiting factor) as opposed to sorting methods where no output is available for display until the whole list is sorted.

Despite these limitations, comparison sorts offer the notable practical advantage that control over the comparison function allows sorting of many different datatypes and fine control over how the list is sorted.

As initially discussed above, at 410, a comparison of the cigar band image is made to the stored database, stored information, or otherwise named cigar brand catalogue is made, to determine if at least one indexed and catalogued cigar brand is the same, similar or different than the resultant cigar band image. For these purposes, comparisons can be made, for example, using a sorting algorithm. Sorting algorithms are an important part of managing data. Various sorting algorithms are contemplated, and can be executed using a variety of methods and coding languages and communication methods, as described above. Each algorithm has particular strengths and weaknesses, however, any number of sorting algorithms can be used alone, individually, consequentially, or in some form of combination based on the type and content of information data to reviewed through.

Sorting algorithms are usually judged by their efficiency. In this case, efficiency refers to the algorithmic efficiency as the size of the input grows large and is generally based on the number of elements to sort. Most of the algorithms in use have an algorithmic efficiency of either O(n̂2) or O(n*log(n)). A few special case algorithms can sort certain data sets faster than O(n*log(n)). These algorithms are not based on comparing the items being sorted and rely on tricks. It has been shown that no key-comparison algorithm can perform better than O(n*log(n)).

Many algorithms that have the same efficiency do not have the same speed on the same input. First, algorithms must be judged based on their average case, best case, and worst case efficiency. Some algorithms, such as quick sort, perform exceptionally well for some inputs, but horribly for others. Other algorithms, such as merge sort, are unaffected by the order of input data. Even a modified version of bubble sort can finish in O(n) for the most favorable inputs.

A second criterion for judging algorithms is their space requirement—do they require scratch space or can the array be sorted in place (without additional memory beyond a few variables)? Some algorithms never require extra space, whereas some are most easily understood when implemented with extra space (heap sort, for instance, can be done in place, but conceptually it is much easier to think of a separate heap). Space requirements may even depend on the data structure used (merge sort on arrays versus merge sort on linked lists, for instance). A third criterion is stability—does the sort preserve the order of keys with equal values.

All exemplary embodiments of indexing, cataloguing, and sorting methods and calculation algorithms included in this detailed description herein are in no way to be limiting on the inventive concept. All elements described herein are for illustrative purposes only and are not intended to limit the indexing, cataloguing, and/or comparison methods contemplated within the scope and spirit of the present invention.

At 412, if the comparison does not result in the recognition of a known cigar brand, the process ends at terminator 420. An unknown cigar brand, in the context of the present invention can be defined, for example, by the type and/or combination of cigar band artwork image quantifiers not comparable with the existing stored, indexed and catalogued known cigar brands, as well as content contemplated in the sorting algorithm used. If an unknown brand is determined, for example, a screen may display to a user which gives the user an opportunity to take another photo of the cigar band, enter specific data regarding the cigar band, enter any known brand data about the cigar, or the like. Further embodiments may contemplate the display of an error message or the resetting and restart of the application software.

However, if the comparison at 412 results in a known brand, one optional process step may include, for example, a geographical location search being conducted at 414 to determine the location of the user device. Geographic location may, for example, be a factor in determining a purchasing modality for the cigar brand, discussed below.

The geographical location search conducted at 414 can include a determination of geographic position contemplated using any number of location methods, processes, applications, programs, and/or algorithms. Multiple embodiments of geolocation, geographical location software and applications and mapping elements are considered. One exemplary system for determining a geographic location includes, but is not limited to Global Positioning System (GPS), a space-based satellite navigation system that provides location and time information in all weather conditions, anywhere on or near the Earth where there is an unobstructed line of sight to four or more GPS satellites. The system provides critical capabilities to military, civil and commercial users around the world. It is maintained by the United States government and is freely accessible to anyone with a GPS receiver. Advances in technology and new demands on the existing system have now led to efforts to modernize the GPS system and implement the next generation of GPS III satellites and Next Generation Operational Control System (OCX). In addition to GPS, other exemplary systems in use or under development include the Russian Global Navigation Satellite System (GLONASS), developed contemporaneously with GPS, but suffered from incomplete coverage of the globe until the mid-2000s. There are also the planned European Union Galileo positioning system, Chinese Compass navigation system, and Indian Regional Navigational Satellite System.

One component of a system in which process 400 would be executed, specifically geographical location search 414, would require the use of a GPS or other locational information receiver. GPS or locations receivers come in a variety of formats, for example, from devices integrated into cars, phones, and watches, to dedicated devices. A majority of user devices as described and detailed in FIG. 1 are contemplated to have elements of location receivers as integrated into, attachable to, and/or functioning as part of the devices. In general, GPS receivers are composed of an antenna, tuned to the frequencies transmitted by the satellites, receiver-processors, and a highly stable clock (for example, a crystal oscillator). They may also include a display for providing location and speed information to the user. A receiver is often described by its number of channels: this signifies how many satellites it can monitor simultaneously. GPS receivers may include an input for differential corrections, using the RTCM SC-104 format. This is typically in the form of an RS-232 port at 4,800 bit/s speed. Data is actually sent at a much lower rate, which limits the accuracy of the signal sent using RTCM. Receivers with internal DGPS receivers can outperform those using external RTCM data. units commonly include Wide Area Augmentation System (WAAS) receivers.

If at 412, the comparison results in a number of similar cigar brands being determined, a list, for example, of cigar brands may be displayed to the user. The list may be displayed, for example, based on user based a previously determined user setting (as discussed above), a random ranking method, or any other functionally necessary ranking method. Furthermore, if a geographical location is determined at 514, the list, may, for example, be displayed in order of regional distance of the cigar brand from the user device.

A further aspect of the geographic comparison at 514 can include authentication and review of privacy-publicity settings for each of the at least one user entities determined to have both similar and/or same user entity preference designations and a geographical location proximity that is in accordance with user entity preferences. Authentication of user entities and their user entity devices can occur through various methods and embodiments as contemplated to be used alone, in conjunction or integrated into the system, methods, and processes which are part of the inventive concept.

Authentication can be defined as the act of confirming the truth of an attribute of a datum or entity. This might involve confirming the identity of a person or software program, tracing the origins of an artifact, or ensuring that a product is what its packaging and labeling claims to be. Authentication often involves verifying the validity of at least one form of identification.

In one embodiment, a secure key storage device can be used for authentication in consumer electronics, network authentication, license management, supply chain management, and any other system or process that requires an authentication element. Generally, for example, the device to be authenticated can have some sort of wireless or wired digital connection to either a host system or a network. The component being authenticated need not be electronic in nature as an authentication chip can be mechanically attached and read through a connector to the host e.g. an authenticated ink tank for use with a printer. For products and services that these secure coprocessors can be applied to, they can offer a solution that can be much more difficult to counterfeit than most other options while at the same time being more easily verified.

The process of authorization is distinct from that of authentication. Whereas authentication is the process of verifying that “you are who you say you are”, authorization is the process of verifying that “you are permitted to do what you are trying to do”. Authorization thus presupposes authentication. For example, a client showing proper identification credentials to a bank teller is asking to be authenticated that he really is the one whose identification he is showing. A client whose authentication request is approved becomes authorized to access the accounts of that account holder, but no others. However note that if a stranger tries to access someone else's account with his own identification credentials, the stranger's identification credentials will still be successfully authenticated because they are genuine and not counterfeit, however the stranger will not be successfully authorized to access the account, as the stranger's identification credentials had not been previously set to be eligible to access the account, even if valid (i.e. authentic).

Similarly when someone tries to log on a computer, they are usually first requested to identify themselves with a login name and support that with a password. Afterwards, this combination is checked against an existing login-password validity record to check if the combination is authentic. If so, the user becomes authenticated (i.e. the identification he supplied in step 1 is valid, or authentic). Finally, a set of pre-defined permissions and restrictions for that particular login name is assigned to this user, which completes the final step, authorization. Even though authorization cannot occur without authentication, the former term is sometimes used to mean the combination of both.

One exemplary use of authentication and authorization is access control. In one embodiment of the present process, a user entity device is contemplated to be used only by those authorized, and attempts to detect and exclude the unauthorized are considered. Access to a user entity device should then, generally, be controlled by insisting on an authentication procedure to establish with some degree of confidence the identity of the user, granting privileges established for that identity. Further exemplary examples of access control involving authentication include, but are not limited to, using a captcha or other recognition software application as a means of asserting that a user is a human being and not a computer program, by using One Time Password (OTP), received on a tele-network enabled device like mobile phone, as an authentication password/PIN, A computer program using a blind credential to authenticate to another program, using a confirmation E-mail to verify ownership of an e-mail address.

In additional exemplary embodiments of the present process, ease of access may be balanced against the strictness of access checks. In one example, a credit card network infrastructure may be modeled but where the system does or does not require a personal identification number for authentication of the claimed identity.

At 412, further embodiments of the present invention contemplate the user having permissions to optionally manually check of brand name. This optional manual check may occur, for example, through re-display of artwork, an option for a user to manually enter brand information, the option to re-create the scan of the cigar band artwork to create a new resultant cigar band image.

At 416, at least one provider of the cigar brand is displayed to the user. The provider information can be stored, indexed and/or catalogued as described above, but is not required to be so. As sellers of goods and services like those contemplated to provide cigars for sale to users, such information is regularly changing and provided to mapping and/or location websites and service providers. Such mapping and location services, such as, for example, Google Maps, and Yelp! And other such services, may be linked to the subject application manner in a commonly known manner so that as a GPS location is determined at 414, a second option search of retailer information and/or location may also be conducted, for example, contemporaneously, following or otherwise in conjunction with the determination of the location of the user device.

Furthermore, providers may be determined at 416 in accordance with a previously determined user setting. One example, includes, but is not limited to, a user determining that all service providers should be brick and mortar retail establishments, for example, cigar bars, liquor stores, convenient stores, and the like. Another example includes, but is not limited to, a user determining that all service providers offer the cigar brand for sale through the internet. It is also contemplated that a user have the option to determine a radius of providing brick and mortar retail establishments and/or web-based brand providers. A default configuration is further contemplated, for example, where a pre-determined mix of brick and mortar retail establishments and online providers are further provided to a user.

At 418, at least one price of the cigar brands is provided. The display and/or listing of the price may occur simultaneously with the display of the cigar brand providers offering the cigar brands for sale. However, display of the price does not require the display of an offer for sale of the cigar brand. It is contemplated, in one non-limiting exemplary embodiment, that a user may create a user preference whereby the user is optionally able to see a price for a cigar brand and save the price to a note and/or text section of the application software.

Further non-limiting and non-essential embodiments are further contemplated, for example, a user having the option to send and receive a scanned cigar band image via a social media platform or other internet based communications methods; select at least one user preference which allows for a remote network device to provide at least one other cigar brand to the user based on the scanned cigar band image. Also optional features may include a not taking section, a live feed and/or live and/or virtual settings for users to enjoy purchases together, for example, a virtual cigar bar.

The process thereafter ends at 520.

Additional methods, aspects and elements of the present inventive concept are contemplated in use in conjunction with individually or in any combination thereof which will create a reasonably functional method, system and device to be of use as a cigar band recognition interface. It will be apparent to one of ordinary skill in the art that the manner of making and using the claimed invention has been adequately disclosed in the above-written description of the exemplary embodiments and aspects. It should be understood, however, that the invention is not necessarily limited to the specific embodiments, aspects, arrangement and components shown and described above, but may be susceptible to numerous variations within the scope of the invention.

Moreover, particular exemplary features described herein in conjunction with specific embodiments and/or aspects of the present invention are to be construed as applicable to any embodiment described within, enabled thereby, or apparent wherefrom. Thus, the specification and drawings are to be regarded in a broad, illustrative, and enabling sense, rather than a restrictive one.

Further, it will be understood that the above description of the embodiments of the present invention are susceptible to various modifications, changes, and adaptations, and the same are intended to be comprehended within the meaning and range of equivalents of the appended claims.

Therefore, I claim:

1. A network device, comprising:
a transceiver to send and receive data over a network; and
a processor that is operative on the received data to perform actions, comprising:
scanning a cigar band to create a cigar band image;
comparing the cigar band image with at least one other cigar band image which is catalogued, indexed, and stored to determine a cigar brand; and
displaying to a user said cigar brand and at least one price of said cigar brand.

2. The network device of claim 1, wherein the performed actions further comprise:
receiving a geographical location marker for the network device scanning the cigar band; wherein, comparing the cigar band image with the at least one other cigar band image further comprises comparing with the received geographical location marker with at least one known geographical location marker of a distributor of said cigar brand, where a proximity marker is used to determine whether at least one physical distribution location is displayed or whether at least one ecommerce platform is displayed.

3. The network device of claim 1, wherein the performed actions further comprise:
displaying to the user at least one cigar rating determined by comparison of said cigar brand to a database of at least one other cigar rating.

4. The network device of claim 1, wherein the performed actions further comprise:
cataloguing, indexing, and storing the cigar brand image at a time of determining said cigar brand, wherein the catalogued, indexed and saved cigar band image is used for at least one other comparison; and
wherein the user can access all saved cigar band images on a network device.

5. The network device of claim 1, wherein the performed actions further comprise:
providing the user with one or more interface display screens on which the user selects at least one user preference, wherein selecting at least one user preference allows the user to:
create at least one text and image note connected to the scanned cigar band image;
send and receive the scanned cigar band image via a social media platform or other internet based communications methods; and
select at least one user preference which allows for a remote network device to provide at least one other cigar brand to the user based on the scanned cigar band image.

6. The network device of claim 1, wherein the performed actions further comprise:
scanning a three dimensional image of the cigar band to create the cigar band image;
flattening said three dimensional image to determine at least one image marker; and
recognizing said cigar brand based on the at least one image marker.

7. The network device of claim 1, wherein the performed actions further comprise:
imposing a grid over the scanned cigar band image to create at least one image marker; and
assigning a value to the at least one image marker based on a value table comprised of values assigned to at least one cigar band image by at least one cigar manufacturer.

8. A system, comprising:
one or more user entity devices; and
a network device comprising a processor and configured to communicate with the one or more user entity devices over a network, and to perform actions comprising:
scanning, via the network device, a cigar band to create a cigar band image;
comparing, via the network device, the cigar band image with at least one other cigar band image which is catalogued, indexed, and stored to determine a cigar brand; and
displaying, via the network device, to a user said cigar brand and at least one price of said cigar brand.

9. The system of claim 8, wherein the network device performs actions further comprising:
receiving a geographical location marker for the network device scanning the cigar band; wherein, comparing the cigar band image with the at least one other cigar band image further comprises comparing with the received geographical location marker with at least one known geographical location marker of a distributor of said cigar brand, where a proximity marker is used to determine whether at least one physical distribution location is displayed or whether at least one ecommerce platform is displayed.

10. The system of claim 8, wherein the network device performs actions further comprising:
displaying to the user at least one cigar rating determined by comparison of said cigar brand to a database of at least one other cigar rating.

11. The system of claim 8, wherein the network device performs actions further comprising:
cataloguing, indexing, and storing the cigar brand image at a time of determining said cigar brand, wherein the catalogued, indexed and saved cigar band image is used for at least one other comparison; and
wherein the user can access all saved cigar band images on a network device.

12. The system of claim 8, wherein the network device performs actions further comprising:
providing the user with one or more interface display screens on which the user selects at least one user preference, wherein selecting at least one user preference allows the user to:
create at least one text and image note connected to the scanned cigar band image;
send and receive the scanned cigar band image via a social media platform or other internet based communications methods; and
select at least one user preference which allows for a remote network device to provide at least one other cigar brand to the user based on the scanned cigar band image.

13. The system of claim 8, wherein the network device performs actions further comprising:
scanning a three dimensional image of the cigar band to create the cigar band image;
flattening said three dimensional image to determine at least one image marker; and
recognizing said cigar brand based on the at least one image marker.

14. The system of claim 8, wherein the network device performs actions further comprising:
imposing a grid over the scanned cigar band image to create at least one image marker; and
assigning a value to the at least one image marker based on a value table comprised of values assigned to at least one cigar band image by at least one cigar manufacturer.

15. A non-transitory computer readable storage medium having computer-executable instructions, the computer-executable instructions when installed onto a computing device enable the computing device to perform actions, comprising:
scanning a cigar band to create a cigar band image;
comparing the cigar band image with at least one other cigar band image which is catalogued, indexed, and stored to determine a cigar brand; and
displaying to a user said cigar brand and at least one price of said cigar brand.

16. The non-transitory computer readable storage medium device of claim 15, wherein the actions further comprise:
receiving a geographical location marker for the network device scanning the cigar band; wherein, comparing the cigar band image with the at least one other cigar band image further comprises comparing with the received geographical location marker with at least one known geographical location marker of a distributor of said cigar brand, where a proximity marker is used to determine whether at least one physical distribution location is displayed or whether at least one ecommerce platform is displayed.

17. The non-transitory computer readable storage medium device of claim 15, wherein the actions further comprise:
displaying to the user at least one cigar rating determined by comparison of said cigar brand to a database of at least one other cigar rating.

18. The non-transitory computer readable storage medium device of claim 15, wherein the actions further comprise:
cataloguing, indexing, and storing the cigar brand image at a time of determining said cigar brand, wherein the catalogued, indexed and saved cigar band image is used for at least one other comparison; and
wherein the user can access all saved cigar band images on a network device.

19. The non-transitory computer readable storage medium device of claim 15, wherein the actions further comprise:
providing the user with one or more interface display screens on which the user selects at least one user preference, wherein selecting at least one user preference allows the user to:
create at least one text and image note connected to the scanned cigar band image;
send and receive the scanned cigar band image via a social media platform or other internet based communications methods; and
select at least one user preference which allows for a remote network device to provide at least one other cigar brand to the user based on the scanned cigar band image.

20. The non-transitory computer readable storage medium device of claim 15, wherein the actions further comprise:
scanning a three dimensional image of the cigar band to create the cigar band image;
flattening said three dimensional image to determine at least one image marker;
imposing a grid over the scanned cigar band image to create at least one image marker;
assigning a value to the at least one image marker based on a value table comprised of values assigned to at least one cigar band image by at least one cigar manufacturer; and
recognizing said cigar brand based on the at least one image marker.
